(19) United States
(12) Patent Application Publication
(10) Pub. No.: US 2018/0169974 A1
(43) Pub. Date: Jun. 21, 2018

(54) METHOD AND SYSTEM FOR MAKING SLOT CELLS BY PULTRUSION

(71) Applicant: Siemens Energy, Inc., Orlando, FL (US)

(72) Inventors: Simon P. Hermes, Chattanooga, TN (US); James V. Johnson, Fyffe, AL (US)

(21) Appl. No.: 15/381,619

(22) Filed: Dec. 16, 2016

(51) Int. Cl. B29C 70/52; B29C 70/54

(52) U.S. Cl. CPC B29C 70/521; B29K 2063/00; B29C 70/545; B29C 70/528

(57) ABSTRACT

A method and a system for making a rotor slot cell by pultrusion are presented. The slot cell is positioned in a rotor slot between a rotor winding and a rotor body for insulation. Reinforcement material is pulled from a roving and passes through a resin tank for impregnation with resin mixture in the resin tank. The impregnated reinforcement material is cured in a die having a shape of the rotor slot. The cured reinforcement material is pulled from the die and cut to a predefined dimension for making the slot cell. The method significantly reduces cycle time for manufacturing slot cells and increases product output.

### FIELD OF THE INVENTION

This invention relates generally to a method and a system for making slot cells, in particular, by pultrusion process.

### DESCRIPTION OF THE RELATED ART

A generator is a component in a power plant that generates power output. A generator may include a rotor and a stator. The rotor may include a rotor body including a plurality of slots therein. A plurality of rotor windings may be positioned in the slots. The rotor winding may need to be insulated from the rotor body to allow current flow in the rotor windings. The current flow may enable an electro-magnetic field. The electro-magnetic field may induce a voltage into stator windings to generate power output.

The rotor windings may be insulated from the rotor body by lining the slots where the windings are placed with insulation. The insulation may be referred to as a rotor slot cell. Typically, rotor slot cells are made by a step molding process. This process may require specific mold configuration for each rotor design. The mold may be made by press irons. These press irons may be produced to a tight tolerance and requires a long lead time and high cost. The step molding process may take a preparation time, such as more than 5 hours. The step molding process may use hot oil which may be a potential injury and fire risk.

### SUMMARY OF THE INVENTION

Briefly described, aspects of the present invention relate to a method and a system for making slot cells, in particular, by pultrusion process.

According to an aspect, a method for making a slot cell is presented. The slot cell is positioned in a slot of a rotor between a rotor winding and a rotor body for insulation. The method comprises pulling reinforcement material from a plurality of rovings. The method comprises passing the reinforcement material through a resin tank comprising a resin mixture. The reinforcement material is impregnated with the resin mixture while passing through the resin tank such that the reinforcement material is thoroughly saturated with the resin mixture. The method comprises curing the impregnated reinforcement material in a die. The die has a shape corresponding to a shape of the slot. The cured impregnated reinforcement material is formed to the shape of the die having the same shape of the slot. The method comprises pulling the cured reinforcement material from the die by a pulling device. The method comprises cutting the cured reinforcement material by a cutoff device to a predefined dimension for making the slot cell.

According to an aspect, a system for making a slot cell is presented. The slot cell is positioned in a slot of a rotor between a rotor winding and a rotor body for insulation. The system comprises a plurality of rovings of reinforcement material. The system comprises a resin tank arranged downstream of the rovings. The resin tank comprises a resin mixture. The reinforcement material is impregnated with the resin mixture while passing through the resin tank such that the reinforcement material is thoroughly saturated with the resin mixture. The system comprises a die configured to cure the impregnated reinforcement material. The die has a shape corresponding to a shape of the slot. The cured impregnated reinforcement material is formed to the shape of the die having the same shape of the slot. The system comprises a pulling device configured to pull the cured reinforcement material from the die. The system comprises a cutoff device configured to cut the cured reinforcement material to a predefined dimension for making the slot cell.

Various aspects and embodiments of the application as described above and hereinafter may not only be used in the combinations explicitly described, but also in other combinations. Modifications will occur to the skilled person upon reading and understanding of the description.

### BRIEF DESCRIPTION OF THE DRAWINGS

Exemplary embodiments of the application are explained in further detail with respect to the accompanying drawings. In the drawings:

FIG. 1 illustrates a perspective diagram of a generator rotor according to an embodiment;

FIG. 2 illustrates a perspective diagram of a slot cell according to an embodiment;

FIG. 3 illustrates a perspective diagram of a slot cell according to another embodiment; and

FIG. 4 illustrates a schematic diagram of a system for making a slot cell according to an embodiment.

To facilitate understanding, identical reference numerals have been used, where possible, to designate identical elements that are common to the figures.

### DETAILED DESCRIPTION OF INVENTION

A detailed description related to aspects of the present invention is described hereafter with respect to the accompanying figures.

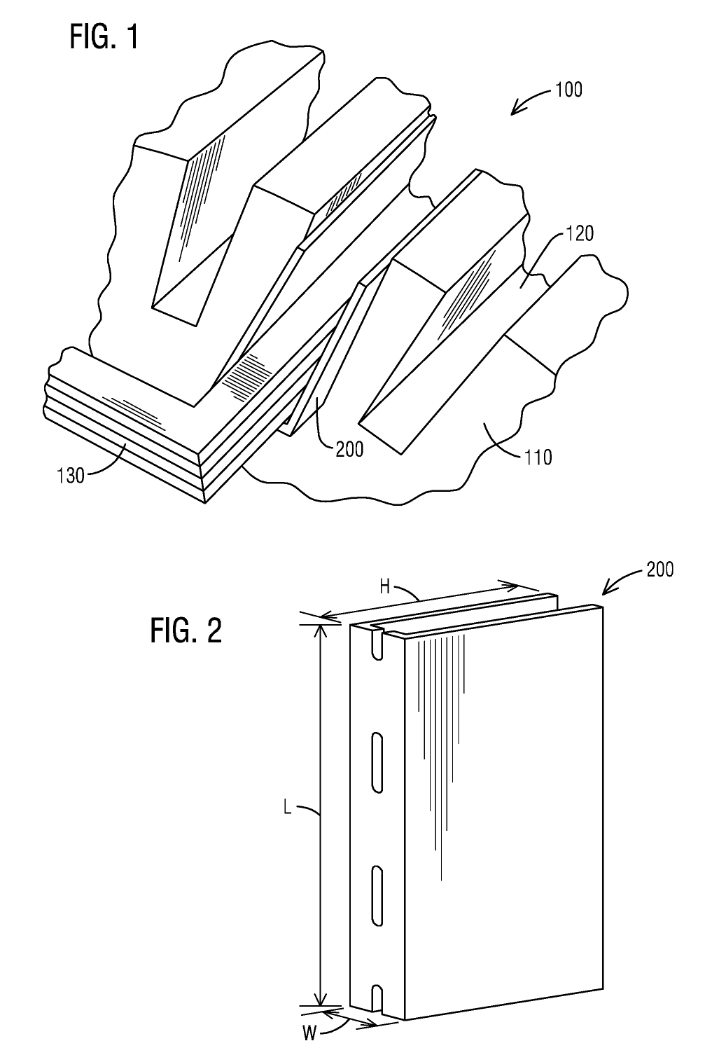

FIG. 1 illustrates a perspective diagram of a generator rotor 100. The rotor 100 may include a cylindrically shaped rotor body 110. An outer surface of the cylindrically shaped rotor body 110 may include a plurality of radial/axial rotor slots 120. The rotor 100 may include a plurality of windings 130. The windings 130 may be positioned into the slots 120. The windings 130 may need to be insulated from the rotor body 110 to allow current flow in the rotor windings 130. A plurality of slot cells 200 may be placed in the slots 120. The slot cells 200 may insulate the windings 130 from the rotor body 110.

Slots 120 may have a plurality of different shapes for different rotor designs. In the exemplary illustrated embodiment of FIG. 1, the slots 120 are U-shaped. Dimensions of slots 120 may be different for different rotor designs. Dimensions of slots 120 may include width W, height H, and length L.

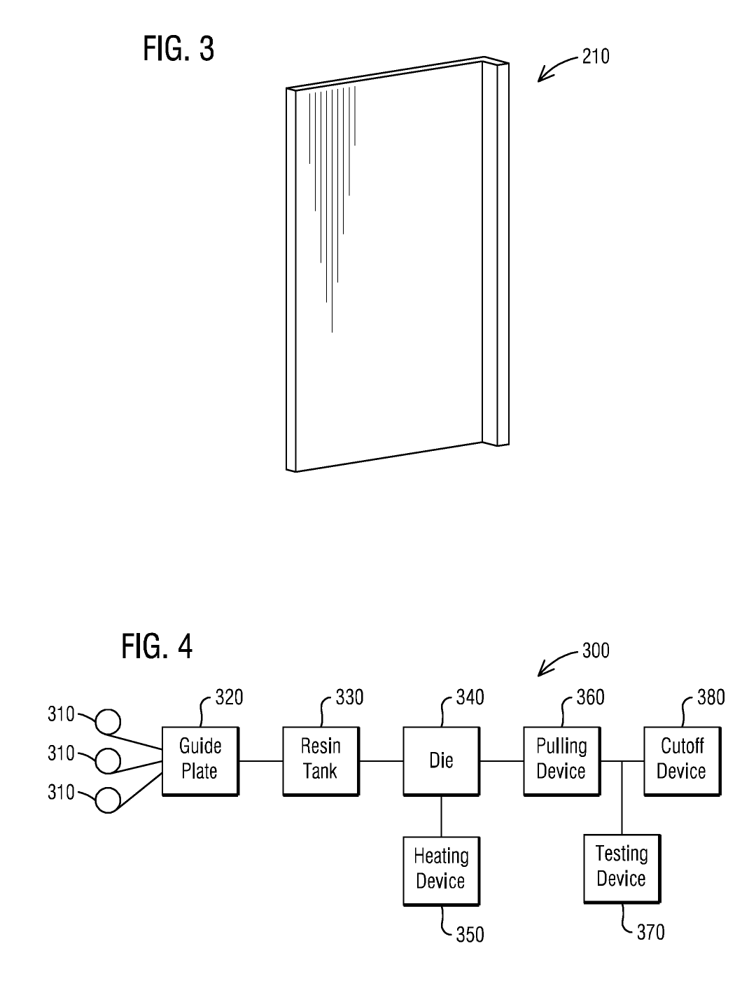

Slot cells 200 may have a plurality of different shapes corresponding to different shapes of slots 120. In the exemplary illustrated embodiment of FIG. 1, the slot cells 200 are U-shaped. The U-shaped slot cells 200 may consist of different profiles. FIG. 2 illustrates an exemplary embodiment of a slot cell 200 having a single U-shaped piece. FIG. 3 illustrates an exemplary embodiment of one L-shaped slot cell piece 210. Two L-shaped slot cell pieces 210 may form a U-shaped slot cell 200.

Dimensions of a slot cell 200 may be defined according to dimensions of a slot 120. For example, width W of a slot cell 200 may be 10 mm, or 20 mm, or 30 mm. Height H of a slot cell 200 may be 100 mm, or 200 mm, or 300 mm. Length L of a slot cell 200 may be 3000 mm, or 5000 mm, or at least 7000 mm. A slot cell 200 may axially extends from either end of a slot 120, such as by about 3 cm. Such additional extension of the slot cell 200 may allow the slot cell 200 for some sliding during rotor operation.

FIG. 4 illustrates a schematic diagram of a system 300 for making a slot cell 200. The system 300 may have a plurality of rovings 310 of reinforcement material. Properties of the reinforcement material may need to meet requirements of the slot cell 200 for a rotor design. The requirements may include dielectric, thermal or mechanical requirements. According to an embodiment, the reinforcement material may include glass fiber, carbon fiber, aramid, or a mixture. The reinforcement material, for example, may include epoxy-glass prepreg, NOMEX® paper, polytetrafluororthylene (PTFE), Teflon® paper, or KAPTON® film.

The system 300 may include a guide plate 320 arranged downstream of the rovings 310. The reinforcement material is pulled from the rovings 310 and continuously fed to the guide plate 320. A resin tank 330 may be arranged downstream of the guide plate 320. The reinforcement material may enter into the resin tank 320 after exiting the guide plate 320. The resin tank 320 comprises a resin mixture. The reinforcement material may become fully impregnated with the resin mixture such that the reinforcement material is thoroughly saturated with the resin mixture while passing through the resin tank 320. According to an embodiment, the resin mixture may include thermosetting resin or thermoplastic resin. The resin mixture, for example, may include polyester, polyurethane, vinylester, epoxy, alkyd, silicone, polybutylene terephalate (PBT), or polyethylene terephthalate (PET).

The system 300 may include a die 340 arranged downstream of the resin tank 330. The impregnated reinforcement material may enter into the die 340 after exiting the resin tank 330. The die 340 may be heated by a heating device 350 to a predefined temperature. The impregnated reinforcement material may be cured by the heated die 340 to become a cured pultruded fiber reinforced plastic composite. The die 340 may be heated to a constant predefined temperature. The die 340 may have several zones of temperature throughout its length. According to an embodiment, the heating device 340 may include, for example, a furnace. The predefined temperature may be at least a Class F (155° C.) insulation temperature. The predefined temperature may be at least a Class H (180° C.) insulation temperature. The predefined temperature may be set to meet an insulation temperature requirement of a slot cell 200 for a rotor design.

The die 340 may have a shape that corresponds to a shape of a slot 120. The cured reinforcement material may be formed to the shape of the die 340 having the same shape of the slot 120. A plurality of dies 340 having different shapes may be designed for different rotor designs. The system 300 may be adjustable for accommodating different dies 340 having different shapes. A die 340 corresponding to a respective rotor design may be arranged in the system 300 for making a slot cell 200 corresponding to the respective rotor design.

The system 300 may include a pulling device 360. The pulling device 360 may be a reciprocating puller or a Caterpillar puller. The pulling device 360 may continuously pull the reinforcement material from the rovings 310. The reinforcement material may pass through the guide plate 320 and may become impregnated in the resin tank 330. The impregnated reinforcement material may be cured and shaped in the die 340. The pulling device 360 may continuously pull the cued reinforcement material from the die 340. The system 300 may include a cutoff device 380. The cutoff device 380 may be a cutoff saw 380. The cutoff device 380 may continuously cut the cued reinforcement material to a predefined dimension for making the slot cell 200. The predetermined dimension may include length, height, width, or thickness of a slot cell 200 corresponding to a rotor design.

The system 300 may include a testing device 370. The testing device 370 may be arranged upstream of the cutoff device 380. In the exemplary illustrated embodiment of FIG. 4, the testing device 370 is arranged between the pulling device 360 and the cutoff device 380. The testing device 370 may perform a continuous test on the cured reinforcement material. The test may ensure that the pultruded slot cell 200 may meet requirements for a rotor design. Test data may be stored in the testing device 370. The test may be performed automatically. The test may include shape test, dimension test, absence of metallic particle test, glass transition temperature test, dielectric strength test, tensile strength test, angle strength test, fiberglass content test, comparative track index test, etc. The testing device 370 may include a dimension laser, a calibrated gauge, a metallic particle tester, a thermal analysis instrument, etc.

The testing device 370 may include a user interface, such as a touch screen, a LCD monitor, or a CRT monitor. Test data of the cure reinforcement material may be displayed on the testing device 370. The testing device 370 may send out an alarm if the test data beyond an allowable tolerance. The allowable tolerance may be predefined to meet requirements for a rotor design. The allowable tolerance may be stored in the testing device 370. Operation parameters of the system 300 may be displayed on the testing device 370. The operation parameters of the system 300 may include load, pull force, pull speed, etc. The testing device 370 may include a control module. The control module may control the operation parameters of the system 300. The control module may control the test on the cured reinforcement material.

According to an aspect, the illustrated process may provide continuous pultrusion for manufacturing slot cells 200. The illustrated process may significantly reduce the cycle time for manufacturing slot cells 200. For example, the cycle time may be reduced to at least one fifth, from at least 5 hours to 1 hour per slot cell 200.

According to an aspect, the illustrated process may allow a much faster and robust production of slot cell 200. The illustrated process may continuously pultrude slot cells 200 at 10 cm lengthwise per minute.

According to an aspect, the illustrated process may allow a little effort to accommodate a different die 340 for a different design of slot cell 200. The system 300 is easily to be adjusted to accommodate a die 340 having a shape corresponding to a shape of different slot cell 200.

According to an aspect, the illustrated process may provide coat savings. The illustrated process may significantly reduce process time for manufacturing slot cells 200. The illustrated process may not require sacrificial material.

According to an aspect, the illustrated process may use a plurality of different composite material for pultruding slot cells 200. The material composition for pultrusion may be adjusted to meet requirements of slot cells 200 for a rotor design, such as dielectric, thermal or mechanical requirements. The material composition may include random glass fiber, mat and epoxy adhesive.

According to an aspect, the illustrated process may continuously perform a test on slot cells 200 during pultrusion. The test may include shape, dimension, insulation temperature, dielectric property, or mechanical property of the slot cell 200. The test may be performed automatically. The illustrated process may ensure that the slot cells 200 made by continuously pultrusion meet requirements for a rotor design.

According to an aspect, the illustrated process eliminates the use of hot oil, thus eliminates a potential injury and fire risk.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

### REFERENCE LIST

100 Generator Rotor
110 Rotor Body
120 Rotor Slots
130 Rotor Windings
200 U-shaped Slot Cell
210 L-shaped Slot Cell
300 System for Making Slot Cells
310 Rovings
320 Guide Plate
330 Resin Tank
340 Die
350 Heating Device
360 Pulling Device
370 Testing Device
380 Cutoff Device

What is claimed is:

1. A method for making a slot cell, wherein the slot cell is positioned in a slot of a rotor between a rotor winding and a rotor body for insulation, the method comprising:
pulling reinforcement material from a plurality of rovings;
feeding the reinforcement material from the rovings to a guide plate;
passing the reinforcement material through a resin tank comprising resin mixture, wherein the reinforcement material is impregnated with the resin mixture while passing through the resin tank such that the reinforcement material is thoroughly saturated with the resin mixture;
curing the impregnated reinforcement material in a die, wherein the die has a shape corresponding to a shape of the slot, and wherein the cured impregnated reinforcement material is formed to the shape of the die having the same shape of the slot;
pulling the cured reinforcement material from the die by a pulling device; and
cutting the cured reinforcement material by a cutoff device to a predefined dimension for making the slot cell.

2. The method as claimed in claim 1, further comprising performing a test on the cured reinforcement material by a testing device.

3. The method as claimed in claim 2, wherein the test is selected from the group consisting of: shape test, dimension test, absence of metallic particle test, glass transition temperature test, dielectric strength test, tensile strength test, angle strength test, fiberglass content test, comparative track index test, and combinations thereof.

4. The method as claimed in claim 1, wherein the curing comprising heating the impregnated reinforcement material to a predefined temperature.

5. The method as claimed in claim 4, wherein the predefined temperature is at least Class F (155° C.) insulation temperature.

6. The method as claimed in claim 4, wherein the predefined temperature is at least Class H (180° C.) insulation temperature.

7. The method as claimed in claim 1, further comprising accommodating a different die having a different shape corresponding to a shape of a different slot.

8. The method as claimed in claim 1, wherein the reinforcement material comprises fiberglass.

9. The method as claimed in claim 1, wherein the resin mixture comprises Epoxy resin.

10. The method as claimed in claim 1, wherein the slot cell comprises a single U-shaped piece or two L-shaped pieces.

11. A system for making a slot cell, wherein the slot cell is positioned in a slot of a rotor between a rotor winding and a rotor body for insulation, the system comprising:
a plurality of rovings of reinforcement material;
a guide plate arranged downstream of the rovings, wherein the reinforcement material is continuously pulled from the rovings and fed into the guide plate;
a resin tank arranged downstream of the guide plate, wherein the resin tank comprise a resin mixture, and wherein the reinforcement material is impregnated with the resin mixture while passing through the resin tank such that the reinforcement material is thoroughly saturated with the resin mixture;
a die arranged downstream of the resin tank, wherein the die is configured to cure the impregnated reinforcement material, wherein the die has a shape corresponding to a shape of the slot, and wherein the cured impregnated reinforcement material is formed to the shape of the die having the same shape of the slot;
a pulling device configured to pull the reinforcement material from the rovings into the die and the cured reinforcement material from the die; and
a cutoff device configured to cut the cured reinforcement material to a predefined dimension for making the slot cell.

12. The system as claimed in claim 11, further comprising a testing device configured to test the cured reinforcement material.

13. The system as claimed in claim 12, wherein the test is selected from the group consisting of: shape test, dimension test, absence of metallic particle test, glass transition temperature test, dielectric strength test, tensile strength test, angle strength test, fiberglass content test, comparative track index test, and combinations thereof.

14. The system as claimed in claim 11, further comprising a heating device configured to heat the die for curing the impregnated reinforcement material to a predefined temperature.

15. The system as claimed in claim 14, wherein the predefined temperature is at least Class F (155° C.) insulation temperature.

16. The system as claimed in claim 14, wherein the predefined temperature is at least Class H (180° C.) insulation temperature.

17. The system as claimed in claim 11, wherein a different die having a different shape corresponding to a shape of a different slot is accommodated in the system.

18. The system as claimed in claim 11, wherein the reinforcement material comprises fiberglass.

19. The system as claimed in claim 11, wherein the resin mixture comprises Epoxy resin.

20. The system as claimed in claim 11, wherein the slot cell comprises a single U-shaped piece or two L-shaped pieces.
